(19) United States
(12) Patent Application Publication
(10) Pub. No.: US 2013/0297458 A1
(43) Pub. Date: Nov. 7, 2013

(54) System and Method for Cooperation Between Online and Physical Value-Chain Endpoints

(71) Applicants: Jean Pierre Rene Marie Van de Capelle, Cambridge, MA (US); Franziska Sabine Frey, Cambridge, MA (US)

(72) Inventors: Jean Pierre Rene Marie Van de Capelle, Cambridge, MA (US); Franziska Sabine Frey, Cambridge, MA (US)

(21) Appl. No.: 13/873,189

(22) Filed: Apr. 29, 2013

Related U.S. Application Data
(60) Provisional application No. 61/641,079, filed on May 1, 2012.

(51) Int. Cl. G06Q 30/06

(52) U.S. Cl. CPC G06Q 30/0635
USPC 705/26.81

(57) ABSTRACT

Methods and systems for making an order at a physical value-chain endpoints, e.g., a physical store using a cooperation manager operating on a processing system. The cooperation manager identifies value-chain members involved for the order and provides for specifying manufacturing and fulfillment process workflows, and determines monetary or other compensation for participation. The cooperation manager for example provides an incentive for a physical store to have a terminal to enable a customer to purchase goods at an online store, such purchasing generating compensation for the store owner. Customers' and recipients' purchasing history may be collected and used to target participants of the cooperation system. Personalized communication can be delivered to one-time customers at participating retail stores.

### RELATED PATENT APPLICATIONS

This invention claims benefit of priority of and is a conversion of U.S. Provisional Patent Application No. 61/641,079, filed May 1, 2012 to inventors Van de Capelle et al., the contents of which are incorporated herein by reference.

### COPYRIGHT & TRADEMARK NOTICES

A portion of the disclosure of this patent document may contain material that is subject to copyright protection. The copyright owner has no objection to the facsimile reproduction by any one of the patent document or the patent disclosure, as it appears in the files or records of any patent office in which the disclosure is filed, e.g., the U.S. Patent and Trademark Office, but otherwise reserves all copyrights whatsoever.

Certain marks may be referenced herein, and such marks may be trademarks or registered trademarks of third parties. Use of these marks is solely for providing an enabling disclosure by way of example and is not to be construed as limiting the scope of this invention to material associated with such trademarks.

### FIELD OF THE INVENTION

The present invention relates to computer-implemented methods and systems usable in a value chain to provide automatic and mutually beneficial cooperation between “bricks and mortar” physical value-chain endpoints, e.g., physical retail stores and online value-chain endpoints, e.g., online stores.

### BACKGROUND

A value chain is a chain which starts with raw material, and includes steps in which value is added to a product up to receipt of the final product, which may be a service, to the end-user (the “customer”). A value chain, for example, can start with an order and end with delivery of the product. The value chain point-of-purchase, where a customer can place an order, is in this disclosure referred to as a “value-chain endpoint.” Such a value-chain endpoint may be physical value-chain endpoint, e.g., a physical facility where a customer can make a purchase. Such a physical facility is called a “physical store” herein, and the owning entity is called a “retailer.” Often the term physical store and retailer are used interchangeably. A typical physical store processes orders, carries inventory, manages inventory, and, in most cases, uses working capital to carry the inventory. A physical store also typically includes knowledgeable staff members who serve a customer. The physical store may allocate precious floor space to display products in the physical store; the displayed products do not have a functional or decorative purpose, other than to attract customers.

Note that the word “retail” in the term retail store and retailer, in the context of the present invention, need not be only mean a physical store where any member of the public can purchase, but, as one example, may be a wholesale warehouse where only particular individuals or businesses may purchase product.

Physical, e.g., retail stores typically specialize in their respective business and manage all aspects associated with that business. They are also assumed, in the example embodiments described herein, to not have a further, finer distribution network of their own. That is, a physical store is the value-chain endpoints where customers physically buy products. The invention, however, is not limited to such a situation, and can handle value chains with sub-chains that are each a value chain, each with a respective value-chain endpoint. For example, a wholesale warehouse where a tradesperson purchases a part is an endpoint of a first value chain that ends with delivery of the part to the customer, in this case the tradesperson. A house owner may have hired the tradesperson to carry out a kitchen renovation, such renovation using the part. In a second value chain, the tradesperson may be an employee of a physical store that sells kitchen renovation services. In the second value chain, the kitchen renovation store is the value-chain endpoint.

Another example of a value-chain endpoint is an online value-chain endpoint, referred to herein as an online store because such a term evokes the physical analogy of buying products or services at a bricks-and-mortar physical store retailer. A customer can buy products or services via an online store over a public network such as the Internet, e.g., using a web browser or a special purpose application (“App”) operating on a device, such as a mobile phone or tablet. Alternative terms for an online store include, inter alia, e-shop, e-store, Internet shop, web-shop, web-store, and virtual store. Such an online store may be presented to a potential customer as an Internet website, whose Web pages may form what is called an online storefront, or as an App on a mobile device which also provides an online storefront.

Online value-chain endpoints in many cases compete with physical store value-chain endpoints, assuming, of course, that the retailer does not also operate the online website. Therefore, a retailer would not be expected to encourage Internet purchases of any product it sells. In particular, a retailer would not be expected to encourage a customer to purchase a product while the customer is at the physical store. When a customer does buy a product online, physical store value-chain endpoint misses out on the purchase so loses revenue. Furthermore, in the case the online customer is or was physically in the physical store, such customer would have interacted with the physical store's personnel to learn about the product, product options, pricing, and so forth. Thus, the retailer has used resources for an assumed potential sale, which does not eventuate.

Suppliers interact with manufacturers to negotiate price for the components that can be integrated into the products. Manufacturers interact with brand owners to negotiate price for manufacturing brand-owner-specified products, which customers can buy at a value-chain endpoint.

Thus, there is an inherent conflict between a physical stores and online value-chain endpoints. This has resulted in many physical stores closing because of inability to compete with online value-chain endpoints.

### BRIEF DESCRIPTION OF THE DRAWINGS

FIG. 1 shows in block diagram form an overview of different steps that may be involved in an embodiment of the invention.

FIG. 2 shows in simplified form an example of a first purchasing scenario at a value-chain endpoint, in this case a physical store using a product identifier, according to an embodiment of the invention.

FIG. 3 shows in simplified form an example of a second purchasing scenario at a value-chain endpoint according to an embodiment of the invention, in which a plurality of identifier carriers, each carrying a respective identifier is used.

FIG. 4 shows in simplified form some example products such as pictures and artwork reproductions, and further shows examples of identifier carriers, e.g., of how the products can be tagged with an identifier.

FIG. 5 shows in simplified form different product identifier carriers, and different connection devices. The connection devices and the products or product displays can be integrated according to one embodiment of the invention.

FIG. 6A shows an overview of a system that includes the cooperation manager and the other different value-chain members and users, according to an embodiment of this invention.

FIG. 6B shows an example set of functional elements for carrying out different functions, according to an embodiment of this invention. The elements shown may, for example, be included in the cooperation manager shown in FIG. 6A.

FIG. 7 shows an example retail environment, including the participants and elements involved in retail purchasing, according to an embodiment of this invention.

FIG. 8 shows a set of example processes that are carried out by the cooperation manager according to one embodiment of the invention.

FIG. 9 shows a simplified block diagram of a processing system in which some embodiments of the invention and that may be present in some system embodiments.

FIG. 10 shows an example of a distributed processing system in which some embodiments of the invention may be carried out, the system including a plurality of computers (each a processing system) coupled by a network, and further coupled to a wider network, e.g., the Internet.

### DESCRIPTION OF EXAMPLE EMBODIMENTS

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be used without departing from the principles described herein.

### SUMMARY

The example embodiments in this disclosure may beneficially provide one or more synergistic cooperation between real world value-chain endpoints, with compensations for the real world value-chain endpoint when customers place an online purchase from the value-chain endpoint, 2) value-chain endpoints not being required to actively manage orders, inventory and delivery processes, 3) creation of new value-chain endpoints from existing value-chain endpoints.

Embodiments of the present invention includes a method, system and apparatus, and a non-transitory computer-readable medium with instructions that when executed, carry out a method. In one embodiment, the method is to operate a cooperation manager that enables customers to make purchases from a value-chain endpoint, for example a retail outlet. The customer, or an employee of the retail outlet, uses a connection device, connecting to an order entry system in the cooperation manager to place the order. In one embodiment, this connection device therefore enables a customer or an operator to place an order in the cooperation manager, or perform another action in that system. The cooperation manager also receives at least one identifier that used to identify the value-chain endpoint and also to determine at least one value-chain member involved in making the purchase and delivering the products to at least one recipient. This determination may also use other purchase information, such as the product the product options, the delivery options, and so forth. All value-chain members can be fairly compensated for their role in the ordering and fulfillment process. These value-chain members can include the value-chain endpoint where the order is placed, brand owners, the manufacturer, suppliers to the manufacturer, the value-chain endpoint where the product is delivered, distributors, and dealers acting as intermediate vale chain members for delivery or for showing the product at the value-chain endpoint where the order is placed.

In one embodiment, the one or more identifiers are communicated from a connection device to the order entry system of the cooperation manager. A customer's mobile phone or a computing device residing at the physical store can be connection devices.

In one embodiment, one or more identifiers are communicated from one or more identifier carriers, inside or outside of the value-chain endpoint, to the connection device and then to the cooperation manager. The identification carriers can for example be part of the product, a product display, part of the physical store, or part of the connection device.

In one embodiment, a processing system, included in the cooperation manager, receives the order information, and the at least one identifier, and stores this information in a non-transitory computer readable medium, e.g., a computer memory or other storage device, e.g., in a computer database. The order information can include delivery options and information from at least one recipient. The processing system is operative to identify all involved value-chain members, from order-entry to delivery, and further is operative to manage the delivery of the at least one product to the at least one recipient.

In one embodiment, the connection device can process the one or more identifiers received from the identifier carriers before sending one or more identifiers to the cooperation manager.

In one embodiment, the value-chain endpoint operative to be the endpoint for placing an order does not have to be involved in the delivery process and may actually be in a completely different business. As an example, a hotel can display a large format framed print, as part of the hotel decoration, serve as a value-chain endpoint for customers to place an order for such a large format print, and have otherwise nothing to do with the business of selling and delivering such prints. As such the hotel decoration provides an additional source of income for the hotel without the hotel having to actively manage inventory and all other aspects of this business. Hotel guests see all aspects of the product they want to buy and can select delivery of the product close to their home at a different value-chain endpoint. That endpoint may not actively carry inventory of this product. As another example the framed large format print can be inside the home of a first customer, who bought it at a first value-chain endpoint, e.g., a retailer. This first customer can now also serve as a value-chain endpoint, and for instance be part of a micro sales network for that retailer. Using a connection device, the first customer can connect to a device or method for establishing itself as a new value-chain endpoint within the cooperation manager. In one embodiment, the first customer can enter the identifier data that was added to the received product. A processing system within the cooperation manager can link the recipient information and identifier data to establish the first customer as new value-chain endpoint. This can lead to rapid multiplication of value-chain endpoints. The first customer does not have to be involved in the physical delivery of the product. In one embodiment, a processing system determines the best delivery and distribution options for the at least one recipient.

The products can be digital products, material products or services that can be delivered or rendered at the value-chain endpoint or at some other place.

Customers can browse the order entry system for products that are not available at the value-chain endpoint and purchase one or more of these products using the online order entry system, while maintaining distribution of compensation, for instance through payment of finder fees or reward points.

In one embodiment, the cooperation manager uses a processing system for determining at least one value-chain member and determining respective compensations to the at least one value-chain member.

Particular embodiments may provide all, some, or none of these aspects, features, or advantages. Particular embodiments may provide one or more other aspects, features, or advantages, one or more of which may be readily apparent to a person skilled in the art from the figures, descriptions, and claims herein.

### DEFINITIONS

In this disclosure the term “product” can mean a physical product, a product display, a service, or a digital product such as a digital picture, digital music, and so forth.

“Value-chain members” include: brand owner, manufacturer, suppliers, distributors, dealers, retailers.

The term “customer” can refer to a company or an individual. The customer purchases products at a “value-chain endpoint,” or may also receive a product at the same or a different value-chain endpoint.

“Purchasing” within this context can also mean renting or leasing.

A “cooperation manager,” according to embodiments of the invention, enables all value-chain members and customers to interact to purchase or order products, to buy or to sell supplies, and to deliver products throughout the value chain, eventually to the receivers, typically the customers who purchase such products.

An “order entry system” allows a person to enter an order into the cooperation manager. An online storefront for an online retailer is an example of an order entry system.

An “identifier” is used to identify a value-chain endpoint. In one embodiment, one ore more identifiers can be used to determine the value-chain endpoint and the value-chain members.

A “connection device” is used to connect to the order entry system. A mobile phone, a portable computer, a tablet or stationary computer are examples of a connection device.

An “identifier carrier” carries an identifier. In an embodiment a carrier can be part of a product or product display. In another embodiment, it can be part of the value-chain endpoint itself. In yet another embodiment an identifier is part of the connection device. An example of an identifier carrier is a tag.

The term “compensation” refers to any kind of reward or consideration that has value. It can be in the form of cash, an award, a purchasing discount, reward points, or equivalent ways to represent value.

Note that the U.S. Patent Rules do not permit this disclosure to include, in print, an actual Web address, URL, or other form of browser executable code. For this reason, when describing a Web address, we denote the period character “.” by ˜dot˜. For example, the Web address of the U.S. Patent and Trademark Office would be denoted as www˜dot˜uspto˜dot˜gov.

### Description of Example Embodiments

### Method and Component Overview of Some Embodiments

The components of an embodiment of the system are distributed over different places, inside and outside of the value-chain endpoints, and as part of a central cooperation manager. The components and their interconnections within different embodiments will be discussed later.

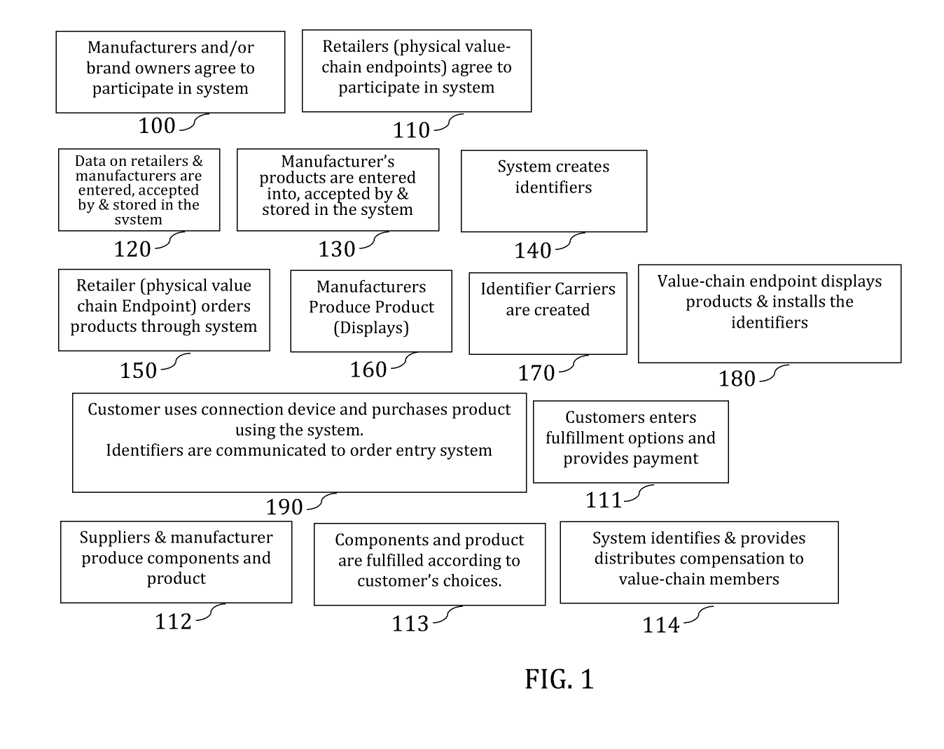

We will first illustrate an overview of different steps of one embodiment using FIG. 1.

### Detailed Description of Method Steps of an Embodiment

FIG. 1 shows an overview of different steps that may be involved in a method embodiment of the invention. These are described below. Different embodiments can be readily envisioned by one of ordinary skill in the art.

### Value-Chain Member Registration

Referring to FIG. 1, in embodiments of the invention, in 100 manufacturers and/or brand owners (referred to simply as manufactures) agree to participate in the system, and in 110 retailers agree to participate. In 120 and 130, data on manufacturer and retailers are entered into the system, accepted thereby, and stored therein. In 130, product data is entered, accepted and stored in the system. Part of the data stored is of brand-owner products offered for sales through the system at participating value-chain endpoints. In one embodiment, some suppliers will also agree to participate in the system and register themselves and enter data related to their product parts into the system, in a step similar to steps 100, 110, 120 and 130.

### Value-Chain Endpoint Identifiers, Product Displays and Identifier Carriers

For each of the value-chain endpoints and, in some versions, for each retailer/product combination, the system creates unique identifiers in step 140. When a value-chain endpoint manager orders products or product displays in (150), the involved manufacturers produce the products or product displays (160). This also involves the manufacturing of components by suppliers, as required. Identifier carriers are created in step (170). In 180, the value-chain endpoint displays the product or product display. The retailer or manufacturer also installs the identifier carriers. In one embodiment, the carrier is part of the product or product display. The identifier carriers may be visible or may be invisible to a human being.

### Purchasing, Manufacturing/Fulfillment Workflows and Compensation Distribution

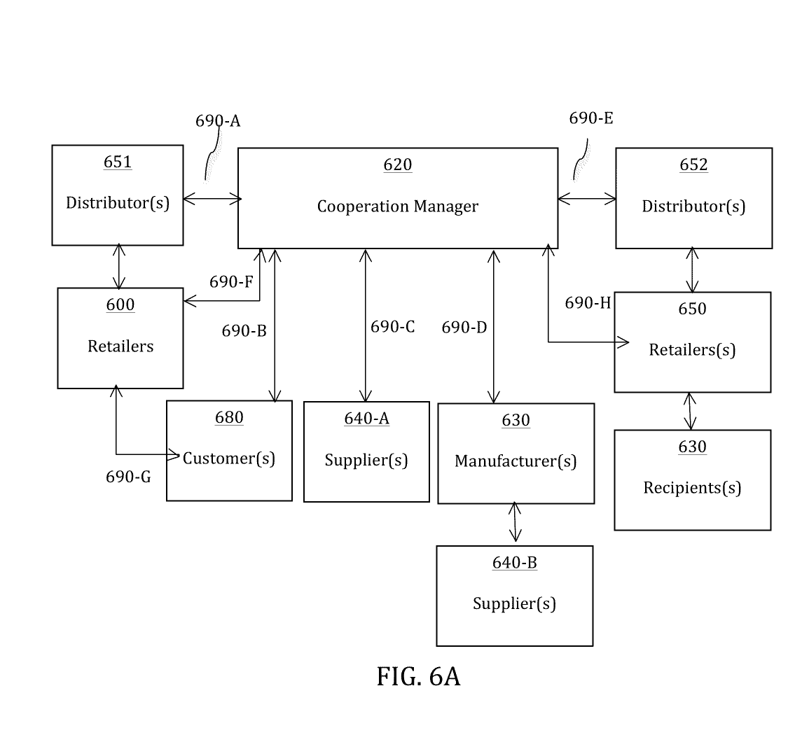

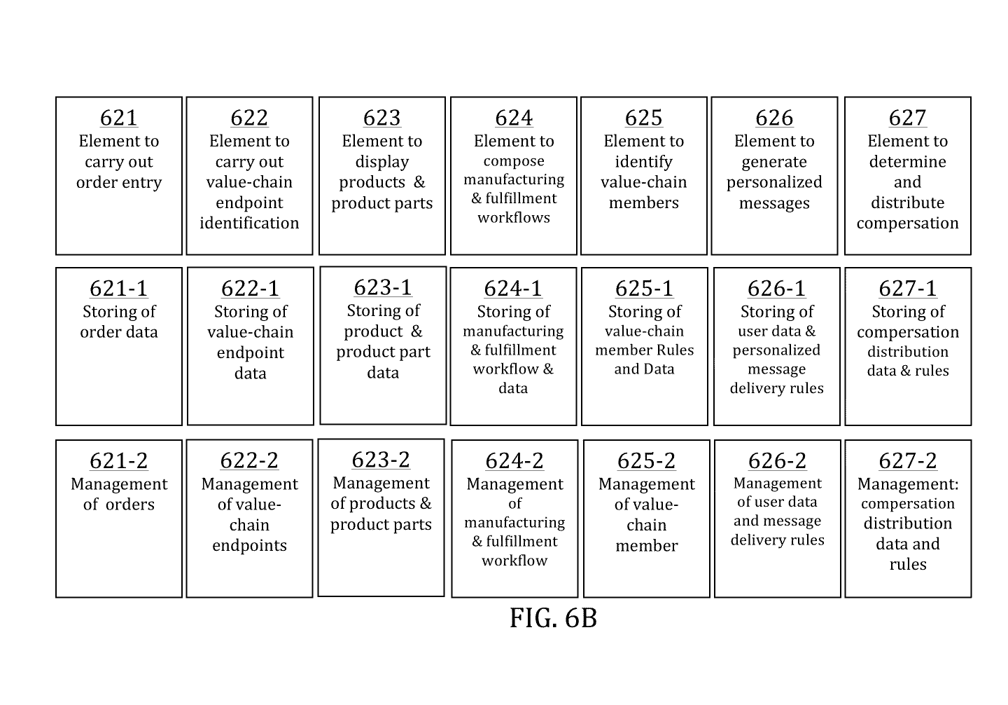

Customers can use a connection device to place an order as shown by (190), and the one or more identifiers are communicated to the order entry system. The customer can enter fulfillment options in (111) and the components and products are manufactured (112) and fulfilled (113). In some embodiments the products have already been manufactured and are available at some of the value-chain members. The system then provides compensation to some or all of the identified value-chain members in step (114). In another embodiment, these are two distinct steps. In another embodiment, more value-chain members participate, as shown in FIG. 6A, which will be discussed later.

Embodiments of the invention provide methods and systems that enable online purchases of products by physical stores providing the mechanism for ordering at an online store, That is, a physical value-chain endpoint serves as an on ramp to one or more online value-chain endpoints participating in the system, as shown in 180 and 190.

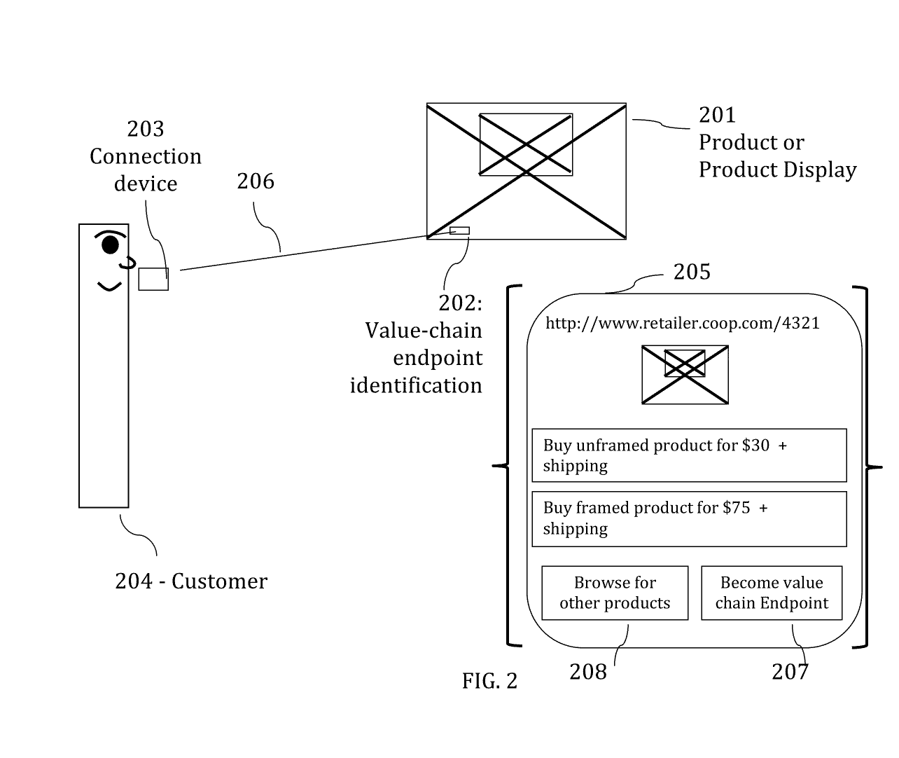

FIGS. 2-5 provide below show in more detail of some of the components and \ functional elements at these value-chain endpoints.

Interaction of Method Steps with Supporting Methods/Functional Element

### Identifying Value-Chain Endpoints

Another aspect of the inventive system includes determining and distributing compensation to the value-chain members, in particular for online sales that originate at physical stores, i.e., the on ramps at such stored. In one embodiment, the online system has knowledge of the history of the order. The system maintains knowledge for each order of which value-chain endpoint where the order originates (step 190), where the produce is to be delivered, and the delivery process to be used up to step 111. In one embodiment, the system includes a method or device operative to identify for each order the respective value-chain endpoints where the order originated.

### Cooperation Between Value-Chain Member

Another aspect of this invention provides value-chain members a mechanism to cooperate by delivering product components, creating complete products with these product components, and displaying a subset of these products at value-chain endpoints. In one embodiment, customers can select the products, product parts and manufacturing and workflow configuration in step 111. The system will then provide compensation to the different value-chain members for the products that a customer ends up purchasing, using the components and the fulfillment workflow of his or her choice, as shown in step 114. FIG. 6B shows such an embodiment example; 623, 623-1, 623-2 are elements to display, store and manage products and product parts, respectively, as provided by different value-chain members shown in FIG. 6A. These elements are described in more detail below. In one embodiment, the module 623 can be used by any of the value-chain members to view products or product parts, and then decide to purchase products or product parts; either as “end products” or as parts to create “end products,” which can be purchased by customers. Manufacturers can purchase product parts from suppliers, retailers can purchase products or product displays from manufacturers or suppliers, and customers can purchase products they compose using compatible product parts and manufacturing and fulfillment workflows.

### Composing Manufacturing and Fulfillment Workflows by Customers

Some embodiments include the feature that the customer can create new products in step 111, using the components of some of the suppliers and select the fulfillment partners for the purchase order. FIG. 1, FIG. 6A and FIG. 6B illustrate an example. A customer can compose manufacturing/fulfillments workflows in steps 190 and 111, using an element 623 operative to display products and product parts 623, and an element 624 for composing manufacturing and fulfillment workflows, which can use a database of workflows stored in element 624-1, and rely on the a workflow management module 624-2. As an example, a customer may decide to purchase a framed artwork reproduction from a manufacturer/print provider, who uses a frame maker as a supplier. The customer may not even know this supplier, shown as 640-B in FIG. 6. However, shipping framed large format artwork reproductions is much more expensive than shipping unframed products, so that it is more reasonable either to carry out selecting a framer close to the recipient to create a frame, or buying a frame from another supplier and carrying out framing and final assembly close to the recipient. In this case the customers and recipients perceive the framers as the final manufacturers and they perceive printers as suppliers. This has profound impacts on the manufacturing and fulfillment process and the associated price and costs, including shipping costs. In one embodiment, manufacturing/fulfillment workflows can be stored in a database of workflows 624-1 and managed by an operator of an embodiment of the system, using 624-2. 624-1 can also store rules and data connected to the workflows. The rules may use product and product part data to determine workflow feasibility or workflow cost. In one embodiment, the composing manufacturing and fulfillment workflows 624 may also use the element operative to identify value-chain members 625, the stored value-chain member rule and data 625-1 and the stored rules and logic for compensating across value-chain members 627-1 to determine cost and price associated with the workflow for the selected products. In one embodiment, users of the system can create workflows, as they decide to cooperate with one another, or as a customer may see fit.

### Distributing Compensation

In one embodiment, 627-1, represents storing the rules, logic and the data for how compensation has to be distributed amongst value-chain members. This stored data 627-1 can in one embodiment be used at the time of order entry to calculate price, for a product, and a manufacturing and fulfillment process selected by the customer. In one embodiment, the rules and data for distributing money amongst value-chain members are dynamic and need to be managed using a management component as represented by 627-2.

In one embodiment, anyone of the players can participate in multiple such cooperation managers.

### Detailed Description of Example Embodiments at the Value-Chain Endpoints

### Conceptual Components at the Value-Chain Endpoint

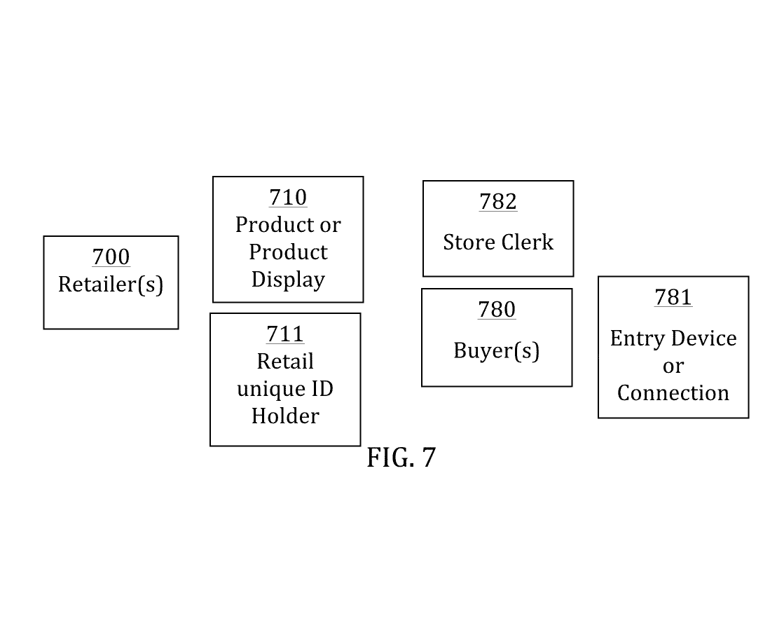

FIG. 7 shows conceptually how in one embodiment, in a retailer environment 700, customers 780 or physical store clerks 782 can use a connection device 781 to access the cooperation manager. The connection device enables the customer to interact with the cooperation manager 620 of FIG. 6A, for instance the customer can interact with the order entry, the displaying product, and the selecting of workflows. The customers see a product or product display 710 in the retail environment 700. A retail unique identifier 711, can be communicated from some place in the physical store, for instance as part of the product display, to the connection device 781, which connects into the cooperation manager of FIG. 6A and can then communicate with 620, and use the identifier as part of the communication. The next paragraphs discuss alternative embodiments.

### Product Displays and Identifiers

In one embodiment, a product display at a retailer carries an identifier. In this case the product display serves as an identifier carrier.

FIG. 2 shows in simplified form an example of a first purchasing scenario at a physical value-chain endpoint according to an embodiment of the invention. 201 represent a product display at a physical value-chain endpoint. In one example the artifact can be a product. In another example it can be a visual representation, such as an electronic display, a digital picture or video, a printed display or poster, a post card, a hologram or any other representation that enables the customer to obtain an idea of the real product. This can have many advantages. In some cases, for example, the physical product does not have to be distributed through a traditional value chain.

In one embodiment, the product display can contain an identifier, as represented by 202. As an example, the identifier can be created at the time of production of the product display, or it can be generated dynamically and displayed on an electronic product display. In an alternative embodiment the identifier is generated separately and sent to the value-chain endpoint. In one embodiment, the identifier 202 is transferred, as illustrated by line 206, to connection device 203, held by customer 204, who sees a view on connection device 203 of the user interface of an order entry system provided by a method or device(s) 621, as shown magnified by 205. This view 205 illustrates that customer 204 can browse for other products, using a method or device(s) for browsing 208 and also chose to become a value-chain endpoint if she desires, as illustrated by user interface component 207.

Kinds of Identifiers and their Meaning

In one embodiment, the identifier is a serial number and this serial number is linked to the retailer by some method, for instance by scanning a barcode when the product arrives at the value-chain endpoint or by entering the serial number and the value-chain endpoint information into the collaborative system 620, using method or devices 622.

In one embodiment, a customer, using an order entry system provided by 621, can enter the identifier manually in connection device 203. In one embodiment, the identifier represents a website page or website portal page. As another example an identifier can be global positioning (GPS) coordinates or other position coordinates, such as a street address of the value-chain endpoint.

In another embodiment, the identifier carrier is present in some place inside the physical store, not necessarily on the product. In one embodiment, an identifier is linked to the retailer's website, a computer's IP address, or MAC address is used. Clearly many other variants can be envisioned.

In one embodiment, the identifier identifies the retailer—the owner of the value-chain endpoint. In another embodiment, the identifier identifies the retail outlet—the value-chain endpoint itself.

In yet another embodiment the identifier represents a combination of product and retailer or retail outlet. In another embodiment, the product identifier is unique to the retailer, meaning that the same product at a different retailer or retail location (value-chain endpoint) has a different identifier.

### Multiple Identifiers and Identifier Carriers

In one embodiment, this is encoded as a single identifier, in another embodiment the retailer identifications and the product identification are separate identifiers.

It will be clear to one of ordinary skill in the art that multiple and single identifiers can be used, transferred, processed, combined and de-combined at anyone place while essentially achieving the same goal. We will refer to any of these cases as “identifiers,” independent of whether it is one or more and independent of their types. Also we will refer to the place or device that holds the identification as an “identifier carrier,” independent of whether it is one identifier or multiple identifier or one or more identifier carriers.

### Detecting Fraud

In one embodiment, element 622 uses value-chain endpoint database 622-1 and a value-chain endpoint management component 622-2, which are used to manage all value-chain endpoints in the system. In one embodiment, the identifying the value-chain endpoint (622) also verifies consistency between multiple identifiers, or between one of the identifiers and an expected value stored in the database (622-1), at the time a customer places an order. In one embodiment, inconsistency verification of the one ore more identifiers is used to detect possible fraud. For instance the GPS coordinates of the connection device and an identifier carried on a tag attached to the product can be matched against one another by as part of identifying the value-chain endpoint 622, using the database 622-1. If the two do not correspond with each other, then there could be a case of fraud, where somebody changed the tag on the product display or somebody moved the product display to a different location. The first one could happen in a more or less public place, like a hotel lobby, and could indicate somebody wants to defraud the hotel of fair compensation distribution. The second could for instance happen when somebody steals the product or product displays, and uses it in a different environment, or because of this it is not used at all anymore. In an alternative embodiment the GPS coordinates of the connection device are matched against the expected data, stored in a database 622-1. When the actual coordinates are too far away from the expected coordinates, a flag is raised to investigate the reason for the discrepancy. In another embodiment, data trends are investigated to detect possible fraud. As an example, consider the case where there is a pattern where customers purchase products at one value-chain endpoint for pickup and payment at a different value-chain endpoint, out of inventory of that endpoint. In such a scenario the first value-chain endpoint may receive finder fees, paid by the cooperation manager; and a scheme could be setup to simulate order entry from a first order value-chain endpoint for pickup at a second in order to repetitively and fraudulently receive additional finder fees. Analyzing time series of purchasing patterns can easily identify such a scheme, for instance by comparing the frequency of this pattern against an average of frequency across multiple value-chain endpoints. It will be clear that different data analysis methods can be used to establish fraud or identifier carrier damage.

### Multiple Identifier Embodiment

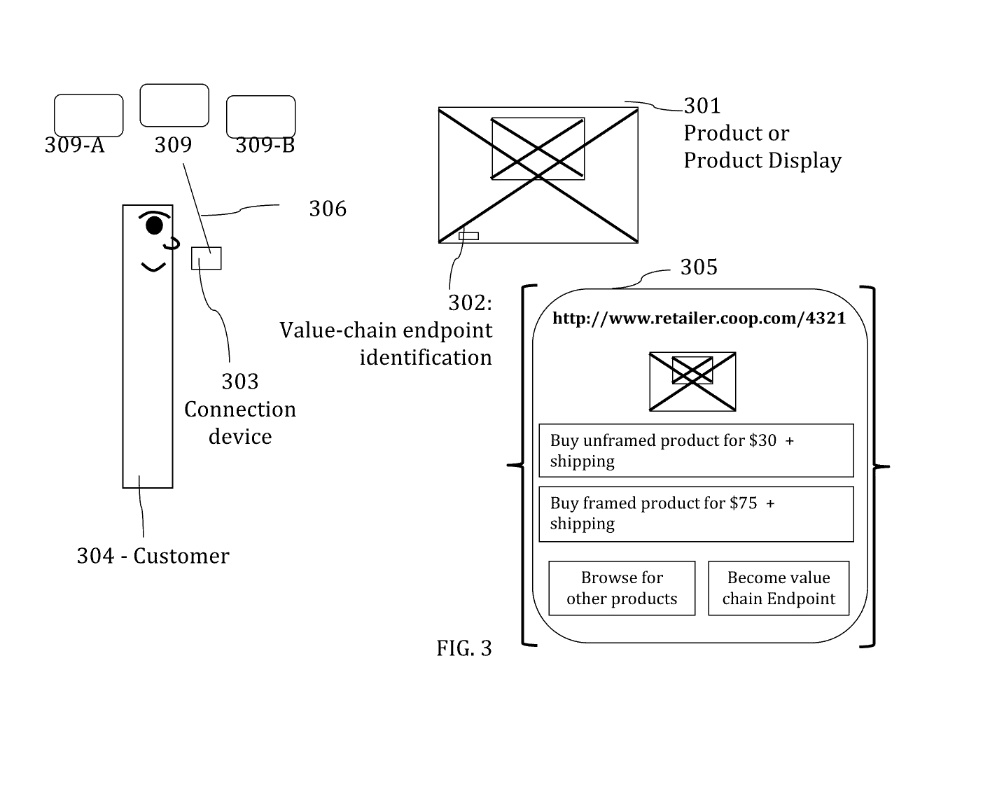

FIG. 3 shows an example of an embodiment in which two kinds of identifiers can be used in combination with identifier consistency checking, as illustrated in for example in FIG. 6B (see below). 302 is an identifier shown near or as part of the product display 301, and 309 are examples of devices that carry an identifier. As an example 309-A is a device inside the physical store, and 309-B represents a satellite which provides GPS coordinates as an identifier. Customer 304 uses connection device 303 to connect to an order entry system. A magnification of an example view of the order entry system, displayed on connection device 303, is shown in 305. Element (622) represents a method or mechanism operative to identify the value-chain endpoint, including checking the consistency of two or more identifiers that are communicated to the central communication system 620. In another embodiment, 622 can provide validation of the identifiers, e.g., are the value-chain members still part of the cooperation manager 120, does the system have valid data for one or more value-chain members, and so forth. In another embodiment, 622 provides verification of one or more identifiers against a database of stored identifiers.

### Optical Identifier Embedding & Tagging Methods

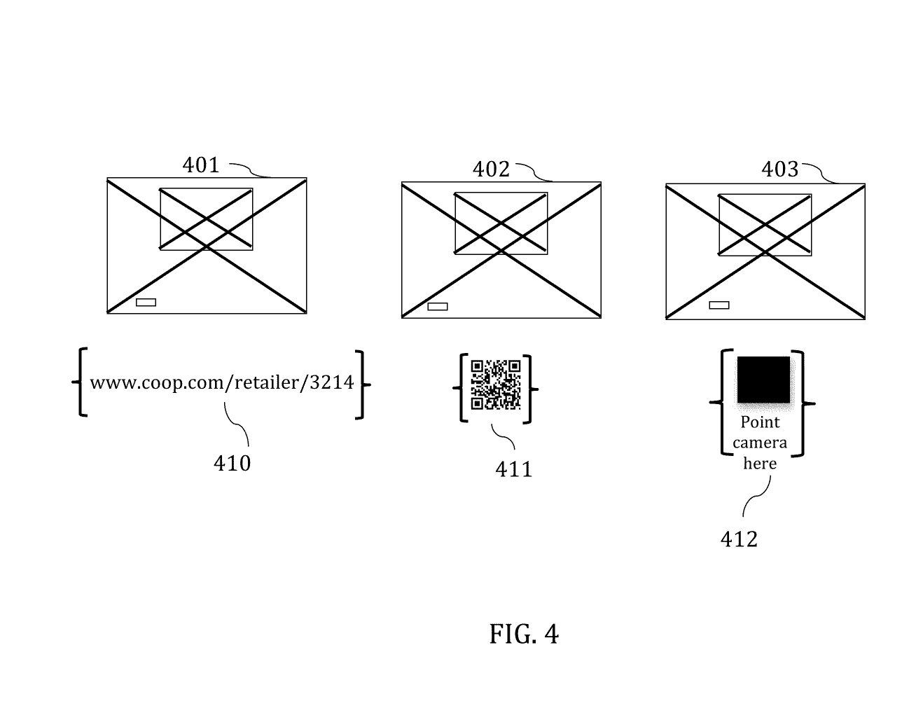

FIG. 4 shows in simplified form some example products such as pictures and artwork reproductions, and further shows examples of identifier carriers, e.g., of how the products can be tagged with an identifier. In particular, FIG. 4 shows products such as pictures and picture frames. For element (401), there is a value-chain endpoint identifier and possibly product identifier located near the bottom left corner of the picture/frame combination and displayed as a website address 410. For element (402), there is a value-chain endpoint identifier and possibly product identifier near the bottom left corner of the picture/frame combination encoded in a 2D barcode or a “Quick Response Code” (QR code), which can contain information on the manufacturer, the brand owner, the value-chain endpoint where the print is displayed, the specific picture or product, and so forth. QR code readers are now ubiquitous, e.g., can be a mobile phone running a QR code reader App. Such an App can include instructions that enable a potential customer to connect into the cooperation manager, according to an example embodiment of the invention. Furthermore, the connection may occur in an automated way. For element (403), identifier 412 is a symbolic representation of a value-chain endpoint and possibly product identifier, embedded in the picture itself. This can for instance be done with glyphs, which are invisible encodings of data in pixels of the pictures, or infrared marking or UV marking with special ink, or any other kind of marking technique, some of which can be invisible to the human eye.

In FIG. 4, identifier tagging examples 410, 411, 412 represent magnifications of the identifiers in 401, 402, 403, respectively. The identifier can of course also be present on the side, the back, the bottom or the top of the artifact, or as a tag which can be hidden behind the artifact and pulled from behind, in order not to interfere with the visual presentation. The tag is an identifier carrier. In some cases the identifier can be machine readable or human readable or both. A QR code is visible to the human eye, but is not human readable for instance. An identifier printed with an infrared ink or UV ink is not visible and therefore also not readable with the human eye only. A text string can be human readable and machine-readable.

### Alternative Wireless Tagging Methods

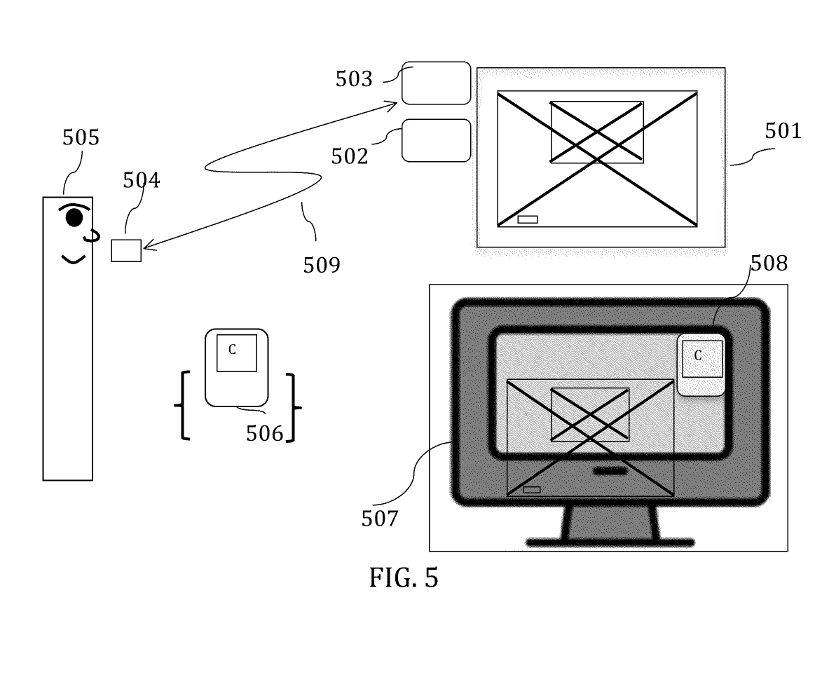

In one embodiment, the identifier can be embedded in the product or in the device used to display the product, for instance in digital files. The identifier can be transmitted to the connection device. FIG. 5 shows a product or product display 501 can transmit the identifier to a connection device 504, the transmitting symbolically represented by line 509, using for instance a wireless communication element 503, 502. Element 503 can for instance be one end of a radio frequency (RF) communication link, while 502 can ne one end of an optical communication link, e.g., an infrared (IR) link. Customer 505 can use connection device 504 to connect to an order entry system, such as that shown in FIG. 6B. Element 506 represents the user interface shown on the connection device 504 that the customer can use to submit an order.

Combined Product Display and Connection Device with Embedded Codes

FIG. 5 shows, according to another aspect of the invention, the case of a product or a product display device 507 temporarily becomes a connection device for the cooperation manager. The identifier, contained in the product, the product display, a computer connected to the display, is communicated to an order entry component (621) shown in FIG. 6B. The product or product display temporarily shows the user interface 508, which enables the customer to place the order with the cooperation manager. The product display 507 can for instance be a touch screen display of a personal computer, or tablet. In such a case the identifier could be the network identifier, e.g., the MAC address of the PC or a combination of this MAC address and another identifier identifying the value-chain endpoint, or some other identifier related to at least one of the value-chain endpoint and the product shown on the display 507.

### Alternative Ways of “Capturing and Communicating Identifiers”

In one embodiment, identifiers can be transferred to the connection device via a machine interface. In another embodiment, identifiers can be transferred manually.

In one embodiment, a customer scans the identifier with a smart phone, which serves as a “connection device,” as for instance illustrated by line 206 in FIG. 2. In one embodiment, that identifier is communicated to a connection device, using some kind of wireless or wired communication. As an example this could be done via optical scanning of, for instance a QR code. Other methods of machine transferable technologies use infrared communication, or RFID tags attached to the product or to a physical store display, a blue tooth or WIFI communication from a device in the physical store to the connection device, communication via a mobile phone network which can determine position information of the connection device, or via a satellite network or any other method of transferring the identifier into the connection device. In one embodiment, the global position (GPS) coordinates of the connection device can determine, co-determine or represent the identifier.

FIG. 3 shows in simplified form an example of a second purchasing scenario. Device 309 communicates with the connection device 303, as illustrated by the line 306, and an application or Web browser running on the connection device 303, an enlargement of an example user interface shown by 305. Device 309 can for instance represent an RFID (radio frequency identification) tag, a satellite transmitting GPS coordinates—as represented by 309-B, a wireless phone communication repeater, a device inside the physical store communicating using such mechanisms as Bluetooth, Wi-Fi, Cellular protocol, or infrared communication, as represented by 309-A. FIG. 3 shows two possible physical examples of a device symbolically represented by device 309.

Any of these methods, not involving any kind of physical attachment of the connection device can in general be labeled “wireless communication.”

Clearly many methods can be used. Any method transferring the identifier into the connection device requiring some kind of physical connection can be labeled a “wired” connection. Alternatively the identifiers can be entered manually, for instance as a website address.

### Multiple Communication Connection Devices Linking to the Cooperation Manager

In one embodiment, the communication responsibilities between an identifier carrier 309 that is in a physical store, connection device 303 and the cooperation manager 620 are shared, and both devices play a role. For instance connection device 303 can function as a display device to enable the customer to interact with cooperation manager 620. In this embodiment communication of some or all of the information happens between 309 and 620, between 309 and 303, and between 303 and 620. In other words the connection device is now implemented over two physical devices 309 and 303.

In one embodiment, part or all of this communication may be encrypted to guarantee safe communication.

Each of these examples enables a potential customer to use the online cooperation manager, shown conceptually in FIG. 6A-System

For simplicity we will assume a single connection device, but clearly it can be implemented using more than one device and more than one device can communicate with the cooperation manager.

Kinds of Products and Purchases of Products Other than the Ones Displayed at Different Points in Time

In one embodiment, of this invention the product that the customer finally ends up buying, may or may not have been the product or product display physically present at the retailer. As the customer uses the cooperation manager, at some point in time or some point in the process, the identifier is communicated, and the customer can browse the website for alternative products or product options, as illustrated by 208 in FIG. 2. The customer can then buy the product at any other point in time, using for instance a mobile device as a connection device. As explained in a previous paragraph, the identifier carrier can be implemented with two physical devices, a mobile device used by the customer and a carrier in the physical store, each carrying an identifier. When the customer buys a product, the appropriate value-chain members will still be compensated in some way; in one embodiment the original retailer and possibly distributors 650 and 651, may receive a finder's fee. When the customer buys a product at a later point in time, the original interaction with the cooperation manager still enables identifying the value-chain members involved, for instance because some data of the interaction, e.g. the identifiers, is stored as part of the customer's data information in 626-1; or because part of the data of the interaction with the cooperation manager is stored in 622-1 and part is stored in 626-1.

As an example of a possible market for this invention disclosure, consider the sale of large format, framed or unframed prints or artwork reproductions. Photographers have high-resolution digital cameras and are taking pictures of certain topics in a certain region. Museums or their partners have high-resolution pictures of artwork they own. These pictures can serve as a source for large format framed or unframed prints, and these photographers, museums or their partners can become suppliers into the cooperation manager. Typically such prints can be offered for sale in shops near the area that has some connections to the picture. Customers can then order large format reproductions using this embodiment.

In another example the customer can upload one or more lower resolution pictures taken with his/her own camera and the final product the customer purchases is one or more (larger format) original paintings of the uploaded pictures. In this case the product display can for instance show an example: a small picture and a larger original painting, which is an enlarged version of that small picture. In another example the product can be a statue or sculpture made using the uploaded pictures as “references.” In another example the product is furniture used at the value-chain endpoint, such as a hotel room or lobby, or a home or an office. In another example the product is apparel, or work tools, or hobby tools. In another example the products can be digital products, music, video, three-dimensional (3D), e.g., holographic images, and so forth. Many other kinds of products can be envisioned.

### Detailed Description of Embodiments of the Cooperation Manager

FIG. 6A shows an overview of endpoint-users, e.g., customers interacting with one embodiment of a cooperation manager 620: users within (a) the manufacturer organizations 630, (b) supplier organizations 640-A and 640-B, (c) retailer organizations 600, 650, (d) distributor organizations 651 & 652, (e) individual customers or customers 680, and finally (f) recipients 630, who can be the same people as the customers or who can be different people, for instance people receiving a present or a post card. Recipients can become customers or can become value-chain endpoints and enable other people to become customers.

User Interacting with the System Components

Users can be organizations or individuals, and organizations can have different users. We will refer to people who are interacting with the system as users, whether they belong to an organization or whether they act as individuals. Users can interact with the system differently, depending on the tasks they want to accomplish and the tasks they are allowed to accomplish.

### Interfaces of the System Components

In one embodiment, of this invention there is a cooperation manager 620, shown in FIG. 6A, which can for instance be accessed through Web interfaces and websites. The arrows, labeled 690-A, 690-B, 690-C, 690-D, 690-E, 690-F, 690-G, and 690-H represent interfaces and interaction capabilities. They can represent human interfaces, for instance in the form of websites or physical interfaces inside a physical store, such as product tags serving as identifier carriers, or programmatic interfaces or a combination. In one embodiment, these interfaces may be integrated with the traditional data processing systems, used at the different value-chain members, with the central cooperation manager 620.

### Components of the Cooperation Manager Supporting the Operation of the Cooperation Manager

FIG. 6B shows details of the element in 620. In this embodiment each of components—the order entry system 621, value-chain endpoint identification 622, displaying products and product parts 623, composing manufacturing and fulfillment workflows 624, value-chain member identification—including customers and recipients, 625, personalized communication 626, distributing money 627, and generation of personalized messages 626—is supported by corresponding storage of data, such as in 621-1, 622-1, 623-1, 624-1, 625-1, 626-1, 627-1, in one embodiment as a database, and corresponding management in 621-2, 622-2, 623-2, 624-2, 625-2, 626-2, 627-2 of the data, including keeping it current, by the different users of the system, according to usage rights and privileges.

In one embodiment, these elements support the operation of the cooperation manager. We will describe one element in more detail. The operation of the other elements shown in FIG. 6B would be clear to one of ordinary skill in the art, such that one skilled in the art can readily create these elements without undue experimentation.

In one embodiment, 625 represents an element operative to identify all value-chain members, based on the value-chain endpoint identification, the selected products/product parts, selected by the customer, and the fulfillment workflows also selected by the customer. In addition this element may use a database or database part 625-1 storing value-chain member data. A value-chain endpoint management module 625-2 is used to manage all aspects of the value-chain endpoints. In one embodiment, element 624, is configured to compose manufacturing/fulfillment workflows in accordance to the customer's manufacturing/fulfillment preference. Element 624 may also a database or database part 625-1. The customer may have cost and delivery options considerations to select the product, product parts, and fulfillment methods, and way all these aspects according to her preferences.

### Detailed Description of the Operation of Embodiments

### Processing and Communicating the Identifier to the Cooperation Manager

In one embodiment, the transferred identifier is processed or transformed within the connection device or at the order entry system to create one or more new codes.

In one embodiment, the connection device sends the identifier or some information embedded in the identifier, or related to the identifier, to the cooperation manager. This can be done using well-known communication and network technologies. It can use a wireless, or a wired network or a combination of both kinds of networks.

In one embodiment, the identifier is communicated at some point in time or some point in the process, for instance at the time of placing the purchase or at the time of entry into the cooperation manager. In an embodiment the purchase can then happen at a later point in time.

In one embodiment, the value-chain endpoint identifier, and possibly also product identifier, is communicated to the system upon entry into this system. The product can then immediately be displayed on the connection device.

In another embodiment, the identifier is transferred at a later point in time, and the user can first perform other operations.

### Identifying Value-Chain Members and Distributing Compensation

In one embodiment, when a customer buys a product, using for instance an online buying process, the identification, the product and the delivery options will be used to determine the involved value-chain members and to compensate them as illustrated in 114; from suppliers 640-A, manufacturers 630, distributors 651&652, to retailers 600&650, as illustrated in FIG. 6A. This scheme can work whether the product is shipped to a value-chain endpoint for pick up by the customer, or directly sent to the customer's preferred destination address. The cooperation manager application can act as an “online version,” or “virtual mirror,” of a more traditional value chain with customer, retailer, possibly distributor(s), manufacturer and supplier(s). Suppliers (640-B) deliver into manufacturers 630 and may be unknown to the cooperation manager.

### Customers Influencing the Manufacturer-Supplier Relationships and Manufacturing and Fulfillment Workflows

In one embodiment, the products displayed on the connection device can come from any of the participating manufacturers or use parts from any of the participating suppliers, and the value-chain endpoints may or may not have the physical products in the physical store.

Suppliers are represented by block 640-A in FIG. 6A that shows an overview of a system that includes the cooperation manager. As examples, the photographers who took the pictures are suppliers, the museum that owns high-resolution pictures of a piece of art acts as a supplier. The manufacturer(s) who produce the large format prints, framed and unframed. Framers can be suppliers 640-B supplying into manufacturers. In some cases large format printers are suppliers 640-A and framers are manufacturers 630 and framing can happen close to the recipient of an unframed reproduction. In those cases the customer, from a value-chain endpoint 600, may select the framer of his choice; and in one embodiment the customer may also select the printer of his choice.

The cooperation website may show variants of the product displayed in the physical store, for instance in different formats, or different kind of frames, or from different suppliers, e.g., different photographers, than the one available in the value-chain endpoint.

When the customer decides to buy a version of the product, many possible delivery scenarios can be followed. One scenario could be that the customer wants the product to be delivered at his home address, or the address of another person, a recipient, or at the physical store 600 the customer is currently in, or at another physical store 650 near the recipient 630. Depending on the scenario different value-chain members can be part of the fulfillment process and different value-chain members can be compensated differently.

### Extending the Value-Chain Endpoint Beyond the Walls of the Physical Location

In one embodiment, a customer can buy a post card or has the ability to send an electronic card to friends and family. In one embodiment, this card can inform the recipient that the post card is a representation of a product, for instance a large format print. The card can contain a reference 202, as shown in FIG. 2, which the recipient of the card can enter into a connection device such as a mobile smart phone or computer of some sort, such as a tablet computer. This then enables the recipient to use the cooperation manager 620 as shown in FIG. 6A of the system overview. In this case the product display resides outside of the physical store. When a recipient of a card now buys the product, for instance a large format picture, through an online process originating from the post card, still different value-chain members may be involved in fulfilling the order. The system can again provide compensation to all value-chain members, including the original value-chain endpoint which sold the post card, or which led to the electronic card to be loaded into the connection device or into another device of the recipient of the card. This provides an example of an embodiment where customers are able to purchase any product in any location, while maintaining the distribution of compensation for participating value-chain members.

In one embodiment, of this invention this reference is an electronic link or website address. In another embodiment, it is a 2D barcode or QR code printed on a paper card. In one embodiment, it is a combination of a link or QR code and an additional identifier to be provided upon entry into the cooperation manager 620. In another embodiment, the electronic “card” is a retailer dependent URL. In another embodiment, the URL also depends on the product.

The electronic card can be transmitted from the physical store to the connection device, or to some other device operated by the customer/customer or by a physical-store clerk. The electronic card can also be sent directly from a device inside the walls of the value-chain endpoint to the recipient.

### Value-Chain Endpoint Multiplication and Propagation to Non Typical Locations

In another embodiment, the system can be extended to work in similar ways for products, which reside inside their final destination environments such as people's homes or offices. In other words a first customer or a recipient of the product can display the product and chose to become a value-chain endpoint and an on ramp into the cooperation manager.

This can be done in different ways, as an example 207 in FIG. 2 presents a user interface for the customer to become a value-chain endpoint. As an example restaurants and hotels can for instance act as retail outlets and have their own identifiers. They can participate in the process without the need for actually executing the many functions retailers normally execute, such as inventory management, sales, website maintenance, customer service, invoicing or payment processing for the sales, and so forth.

In another embodiment, the products shipped to the home of a first customer may contain an identifier that refers back to the original value-chain endpoint. A second customer, visiting the first customer at his/her home or office can now also use the cooperation manager to buy products. In one example the original value-chain endpoint receives a finder fee as if the product were purchased within the walls of the endpoint. In another embodiment, the first customer and the value-chain endpoint can both be identified during the process, because the identifier incorporates information of the first customer and the value-chain endpoint, and they can share the finder's fee in some ratio. In one embodiment, the first customer acts as the on ramp to the system and receives the entire finder's fee; for instance when the first customer bought products directly from a manufacturer, such as hotel furniture used in a hotel.

In one embodiment, the cooperation manager issues the purchase order of the second customer to the original value-chain endpoint, where the first customer bought the product. In one embodiment, the original manufacturer will receive the order from the cooperation manager. In one embodiment, a distributor will receive the purchase order of the second customer.

### Overview of Different Processes

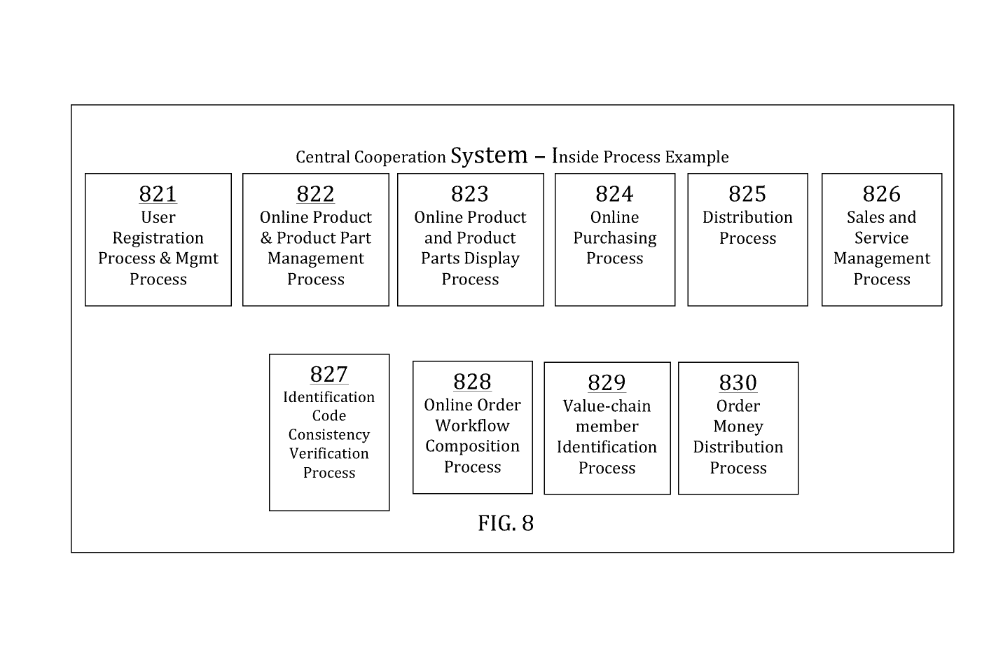

In one embodiment, the cooperation manager 620 supports different processes, which can be executed by individual users or users within the organizations. FIG. 8 shows a set of example processes that are carried out by the cooperation manager 620 of FIG. 6A. In one embodiment, the processes comprise:

(1) A user registration process and user management system 821, which can be implemented in different ways. For example, there can be one registration sub-system for all users of the system, or there can be multiple registration sub-systems processes for different user types. User information can be stored in one or more user databases as part of 821. Users may change their status and in one embodiment customers can for instance become retailers.

(2) An online product and product part management process 822, for suppliers and manufacturers to manage products and products parts. The managing tasks include registering new products or new product parts, setting prices, removing products, uploading information about the products or product parts, and so forth.

(3) An online product and product part display capability 823, which enables users to execute tasks, which include browsing, searching, reviewing products or product parts.

(4) An online purchasing process 824, for customers, retailers, distributors, manufacturers and suppliers to place purchases for products, or product parts.

(5) A distribution process 825 which can effectively and efficiently handle product distribution for any kind of product or product part purchases. In a very general case, distribution involves manufacturers, brand owners, distributors and retailers. In other cases product or product part distribution only involves one or more of these players.

(6) A sales and service management process 826 allows users of the system to execute tasks including: order status inquiries, product order sales inquiries, product service management tasks, and so forth.

(7) An identifier verification process 827, which can establish identifier code consistency and validity, in one embodiment used to detect possible fraud, or issues with the identifier carrier, such as damage.

(8) A process 828, for composing the order's manufacturing and fulfillment workflows, based on the customer's preferences and possibly capabilities of manufacturers and suppliers.

(9) A process 829, for identifying at least one value-chain member, from the value-chain endpoint identification, the product and the workflow. This identifying process can then be used to calculate costs and price by the purchasing process 824.

(10) A process 830, for determining the distribution of compensation to at least one value-chain member, such that all participating value-chain members receive their compensation for the sold products.

Let us first examine example processes from a retailer and customer's perspective; next we will examine some example processes from a supplier and manufacturer's perspective.

### User Registration

The user registration process can have different kinds of functions. As examples these functions can include: registration as a guest user, logging in as a repeat customer, registering as a new customer, logging in as a retailer, supplier, manufacturer, and so forth.

In one aspect of an embodiment, 600 in FIG. 6A, represents retailers or retail outlets. Retailers participating in the system will have to be registered into the system, either through self-registration or by an administrator registering retailers into the system as users of the system belonging to one retail category of users.

User registration and process management 821 of FIG. 8 is used to register users of different categories into the system. As an example, each retailer and participating value-chain endpoint can be uniquely identified into the system.

In one embodiment, once a value-chain endpoint is registered it can be identified by some identifier, or it can identify all their physical locations, each with a unique identifier.

Recipients 630 do not necessarily have to register in the system, but the system does not exclude the possibility that they would be able to or would need to. For instance in one embodiment, recipients may register their product. Registration of products is done often today, and can be done by sending in a physical post card or using an Internet browser. However in one embodiment of this invention, as part of the registration process, recipients can indicate they want to become a value-chain endpoint for this cooperation manager. The cooperation manager can then provide the recipient with an identifier, for instance printed on a label, which can be attached to the product. In another embodiment, the recipient receives an identifier in a digital form. In another embodiment, the physical location information of the recipient is used as the identifier or part of the identifier to identify this new value-chain endpoint. In another embodiment, customers can become value-chain endpoints and indicate that at the moment of purchase.

### Value-Chain Endpoints Purchasing Products

Retailers can search the product catalog for items that are relevant to their area or to the customers that visit them; they can buy, or receive on consignment, products or product displays 710, for display in their physical store. Some embodiments include the feature that these retail versions of the product or product display 710 of FIG. 7 contains an identifier 711.

In one embodiment, the value-chain endpoint is a person who registered into the system as a value-chain endpoint and is making a purchase, for instance for his home or her office, or a piece of apparel for him to wear, or a product to be used on her computer, hobby materials, tools, glasses, and so forth. The person is then identified into the system as a value-chain endpoint in some way or another, for instance by tagging the product purchased with an identifier, or providing the person with an identifier. In one version, someone's office or home becomes a value-chain endpoint for the cooperation manager.

### Customers Purchasing Products

As an example, customers, 780 of FIG. 7 walking around in the physical store, may have or develop a purchasing interest when noticing a product or product display, perhaps because of a very recent experience. The product or product display may enable connection and entry into the central cooperation manager 620, for instance by displaying a website address that contains a retail unique identifier, e.g., in the form of a URL, or in the form of some other identifier. An example URL address identifying a physical store might be www˜dot˜onlinecoopsystem˜dot˜com/retaileridentifier. A product of the store might be identified by www˜dot˜ocs˜dot˜com/retaileridentifier-productidentifier, or by www˜dot˜onlineccoopsystem˜dot˜com/retaileridentifier/productidentifier, and so forth, where, as throughout this disclosure, the character ˜dot˜ denotes the period character in the actual address.

In another embodiment, the website address identifying the physical store and the product may have a format such as www˜dot˜retailer-mfc˜dot˜com and www˜dot˜retailer-mfc˜dot˜com/productIdentifier, respectively, with “mfc” for example, being the name of a brand owner or manufacturer. Other examples include www˜dot˜retailer˜dot˜mfc˜dot˜com, and www˜dot˜retailer˜dot˜mfc˜dot˜com/productIdentifier.

In one embodiment, when a retailer acts as a “distributor” or a “manufacturer” for its customers, that is, its customers are the first customers, the website address of the store identifies the physical store and first customer by taking the forms www˜dot˜retailer˜dot˜com/FirstCustomerIdentifier, and, when the product is included, www˜dot˜retailer˜dot˜com/FirstCustomerIdentifier/ProductIdentifier. In that case the first customer acts as a value-chain endpoint and can buy a product on the retailers website, which acts as one embodiment of a cooperation manager. In one embodiment, the first customer can show the product or a product display in his home or her office and act as a value-chain endpoint for the original retailer, which acts as “distributor” or “manufacturer” and also as the owner of the cooperation manager.

In one embodiment, customers may provide payment at the time of purchase, in another embodiment, customers may have a line of credit or have pre-deposited money into an account held by the system. In yet another embodiment, customers may be invoiced at a later point in time. In another embodiment, customers pay at the time of pickup.

In one embodiment, customer 204 of the first scenario shown in FIG. 2 can use a a connection device 203, which is one example of connection device 781 of FIG. 7. In another embodiment, a physical-store clerk can use such a device 781, to enter into an online or electronic cooperation manager 620. This connection device can for instance be a mobile device 203 of FIG. 2, a phone, a tablet computer, a regular computer, a laptop, or any other kind of device enabling interaction with the cooperation manager 620.

### Product Visualization

In one implementation, after entering into the system, the customer immediately sees the product 710 displayed in the physical store 700 on the display of entry device 781 and decides to purchase the product through the online purchasing process 824, and have it delivered where he/she would like it. The first scenario of FIG. 2 further shows a magnification (205), of an example of what the customer of the product sees on the entry device (203), which is one example of a user interface provided by elements 621 and 623 on connection device (781).

Clearly the representation of the product on the entry device can be a simple 2D visualization or it can be some kind of virtual three-dimensional (3D) visualization. It may require the use of special glasses to see a virtual 3D image, or it may be a rendering of a 3D image on a traditional two-dimensional (2D) display. In another embodiment, the visual representation on the connection device can be a video instead of a still image.

In one embodiment, the product is a digital product and the visualization on the entry device shows the actual product. In one embodiment, it can be shown in less high quality before the product is bought. In some cases the product can be a digital audio product. In that case “displaying” a product can mean, “playing” the product for it to become audible. In such as case a “sample version,” or shorter version may be sent first before buying the full version product. In other cases it can be a video or still image.

In an alternative embodiment and process the customer can browse an electronic product catalog provided by element (623-1) and process 823, and purchase a different product than the product (710) displayed in the physical store (700).

### Fulfillment Processes as Viewed by the Customer

In one embodiment, the distribution and delivery process (825) may be largely invisible to the customer. In alternative embodiments, the distribution process may be explicit and the customer has control over suppliers, manufacturers, and distributors. The customer (680) or (780) may opt for different delivery times, with different pricing or different delivery locations. The distribution process can for instance involve a classical distribution process, with a distributor 652 and a retailer 650 involved in the value chain, to reach the recipient 630, who may pick up the product at a retail location. Alternatively, in another embodiment, the distribution process can use some form of direct mail and not involve distributors or retailers, to reach the recipient 630 directly.

### Delivering Personalized Information

In one embodiment, customers or recipients may use this cooperation manager to find physical stores and products they may enjoy, in the area where they currently are. This can for instance be based on their historical purchase behavior that is known in the system. The order entry system 621 can connect to a database 621-1 storing order information and order data, including historical information, and a management module 621-2 to manage the orders. The historical information stored in 621-1 can be used by in module 626 to generate personalized message. As an example, in one embodiment, customers and or recipients may simply request “points of interest” and the cooperation manager provides sorted list of value-chain endpoints, based on purchasing history. The requested points of interest can be stored in a separate module, 626-1, to store user information, other than customer's order data. That system can be augmented with a set of rules, which can be used by 626 to generate personalized messages. For instance, the aforementioned list of value-chain endpoints can be sorted or filtered in different ways, for instance by topic, by proximity, by spend level, by most recent purchase, by purchase frequency, by purchase frequency away from home, by retailer advertisement contribution level, and so forth. Any selection made by the user can be stored and added to the profile of the user. In another embodiment, customers and or recipients may enter a topic and receive a list of possible retailers where they may find similar products or services. Again this list can be sorted or filtered in different ways as indicated before. As one aspect of this embodiment, the information captured from a user during one interaction cycle with one value-chain endpoint, can be used at a later point in time with another value-chain endpoint. In one aspect of the system, users of the system, using a management module 626-2, can manage rules and user data. Users can include all value-chain members, customers and recipients included.

Details of the Operation from the Perspective of Suppliers and Manufacturers

In one embodiment, suppliers 640-A and manufacturers 630 can register or enter the cooperation manager 620 through the user registration process 821. Suppliers 640-A may offer part products or product components for sale, after registering into the system through the registration process 821. They can enter those products into the system through the product and product part management process 822. The manufacturers 630, making final products, may use the product parts. In one embodiment, these manufacturers also register into the system through process 821 and can browse the system through process 822 for product parts that suit them. Product browsing includes scrolling, keyword searching, and so forth. This process may also involve the product display process 823, using the display component 623. In one embodiment, of this invention the suppliers may set their price for their product part. In another embodiment, others dictate the price of the part in the value chain and suppliers offer their parts at that price. In yet another embodiment there can be a bidding process for product parts to be fulfilled by suppliers.

### Sales and Service Processes

In one embodiment, the customer, recipient as well as suppliers and manufacturers may at some point in time interact with a sales and services management process 826, for instance to monitor or enter delivery status of the product, or for possible product returns in case of product dissatisfaction.

### Distribution of Compensation

In one embodiment, the money flow, e.g., the compensation allocation and distribution amongst the players in the value chain, depends on the entire process, from order entry to order delivery, and different schemes can be envisioned.

The retailer identifier can be used to identify the retail outlet or the retailer, or the parent company or the owner or any party, which can then determine the value chain or the money allocation and distribution chain. In one embodiment, the compensation and distribution system also depends on the product or on the place of delivery. As an example, the retailer 600, or some affiliated entity, at the start of the process can receive a customer finder's fee. This finder's fee can be allocated to some entity related to the retail outlet, e.g., to the specific retail outlet itself, or to its parent company, or to its owner, or to its shareholder, and so forth. In one embodiment, the manufacturer 630 and suppliers 640-A, 640-B may also receive their share of the sale. For instance, in one example the product will be made on demand and shipped to some location, the manufacturers, suppliers and entities involved in the delivery process, will receive some compensation paid by the customer when purchasing the product. In another example the customer may purchase a product that the retailer has in inventory and the customer may decide to take it with him from the physical store. In one embodiment, the retailer can have the product on consignment, and value-chain members will be compensated when the product is purchased. In another embodiment, the retailer already bought the product and some of the value-chain members have already been paid prior to the customer buying the product, and taking it with him from the physical store. In one embodiment, the value-chain endpoint will collect the money from the customer. In another embodiment, the customer decides for the recipient to pickup the product at second, participating retailer, and in one embodiment this second retailer collects the money from the customer who is also the recipient, for instance if the customer purchased a product which the second retailer has in inventory. The first value-chain endpoint will then receive a finder's fee. In another embodiment, the customer pays at the moment of purchase through the cooperation manager, the value-chain endpoint receives a finder's fee. If the recipient picks up the product at a second retailer, then that retailer, and possibly the distributors, as explained below, will receive compensation through the cooperation manager. That compensation can be a regular retailer margin minus the finder's fee of the first value-chain endpoint. In one embodiment, if the product is shipped through the distribution channel to the second retailer, the distributor and retailer will receive handling fees through the cooperation manager. In one embodiment, the participating value-chain members will receive compensation after the recipient received the product in a satisfactory manner.

In one example of this invention, the company setting up, managing and operating the electronic cooperation manager 620 may receive a portion of the transaction. This company could be one of the players of the traditional value chain, for instance it could be the manufacturer, the brand owner or it can be a different entity altogether. It shall be clear that many different scenario variations can be envisioned, and two possible scenarios are summarized in the Table 2 below.

TABLE 2

| Value Chain Partner | Scenario 1 | Scenario 2 |
|---|---|---|
| Retailer 1 | Finder's fee | Finder's fee |
| Distributor 1 | Finder's fee | |
| Manufacturer | Finished good | Finished good |
| | purchase price | purchase price |
| Supplier 1 | Component | |
| | purchase price | |
| Supplier 2 | | Component |
| | | purchase price |
| Supplier 3 | | Component |
| | | purchase price |
| Distributor 2 | Handling fee | |
| Retailer 2 | Handling fee | |
| Shipping company | | Shipping fee |
| Cooperation manager | Infrastructure | Infrastructure |
| owner | usage fee | usage fee |
| Sales taxes | Tax fees | |
| TOTAL PRICE TO | Sum of all of | Sum of all of the |
| CUSTOMER | the above | above |

In one embodiment, one more value-chain members will receive credits or reward points as part of the compensation.

Also, in one embodiment, the total price, inclusive of shipping costs, may depend on the selected distribution process, as discussed before.

Ways to receive compensation electronically are well understood, and could for instance be through crediting a credit card account or any other way to receive money electronically such as electronic transfers between bank accounts.

In one embodiment, some suppliers 640-B, in FIG. 6A, also may not directly interact with the system and may only supply product parts to manufacturer(s) who can interact with the system. In such embodiments those suppliers are paid through the manufacturers and not through the cooperation manager.

### Processes for Personalized Communication to Users

In one embodiment, value-chain members may use the data available in the system to deliver personalized communication. Personalized advertising and communication in general, based on customer buying patterns is well known, yet for small retailers this is almost impossible to do, because of a lack of purchasing data and personal customer data. Using this cooperation manager the data can be captured and stored and now becomes available across value-chain members. Today larger retailers do collect customer data and provide targeted advertising, and they may sell that data to other parties or they may choose not to.

Smaller retailers cannot do this so well, and definitely not when the customers are occasional customers. Also large retailers do not have date on the occasional or one-time customers. Aspects of one embodiment now allow the capturing, storage of data and analysis of that data for the delivery of personalized messages across value-chain members, for the benefit of the customers as well as for the value-chain members.

Therefore one aspect of one embodiment is that it provides a method and a system for value-chain members to collect, store, analyse and access customer data for personalized communication and knowledge sharing. In one embodiment, the data stored can pertain to the customer or pertain to the recipients or to both. Vice versa data and knowledge of manufacturers can be shared with customers and recipients. In one embodiment, customers and recipients may indicate whether value-chain members may provide advertising to them, for which kind of products and/or for which time periods. In one embodiment, the retailers may change the product displays, for instance when electronic displays are used, based on the customer looking at the display and the available information of that customer in the cooperation manager. This aspect of one embodiment combines the use of 623 and 626 at the value-chain endpoint.

In one embodiment, the system may be used to deliver personalized communication to the value-chain members for instance indicating which products sell well in certain settings; encouraging value-chain members to serve customers as best as possible and increase sales numbers for all members of the cooperation manager.

As is obvious from the previous description these processes and the specific functions that can be executed depend on the setup of the system, the user and on the exact role and permissions the user has within the system. Many different variants can be envisioned.

### Ownership of the Cooperation Manager

The methods and systems of this invention can be provided by an independent organization, or, by one or more of the value-chain members. In one instance the cooperation manager can be provided by the manufacturer or by the brand owner, who may have data associated with the other or newest versions of their products available on their data processing management systems, while the physical products are not available in the physical store outlets. In other cases some of the suppliers determine the latest available products on the system. For instance, the newest and latest versions of high-resolution pictures can come from a photographer/supplier and can determine which final product a customer wants. As one aspect of one embodiment of the cooperation, this then provides a significant time and distribution cost savings for the value-chain members, as the customer may now find or create the product on the cooperation website, and purchase it as if he bought it at the value-chain endpoint. In this case an independent party may provide or operate the cooperation manager. The value-chain endpoint would still be awarded some fair value distribution, for example a finder's fee as illustrated in step 114. In one embodiment, there is a module 627 in FIG. 6B, operative to distribute and provide payment to some or all value-chain members based on the value-chain endpoint, the products bought, and the manufacturing/fulfillment workflow used.

### Supporting Infrastructures

### Supporting Computer Infrastructure

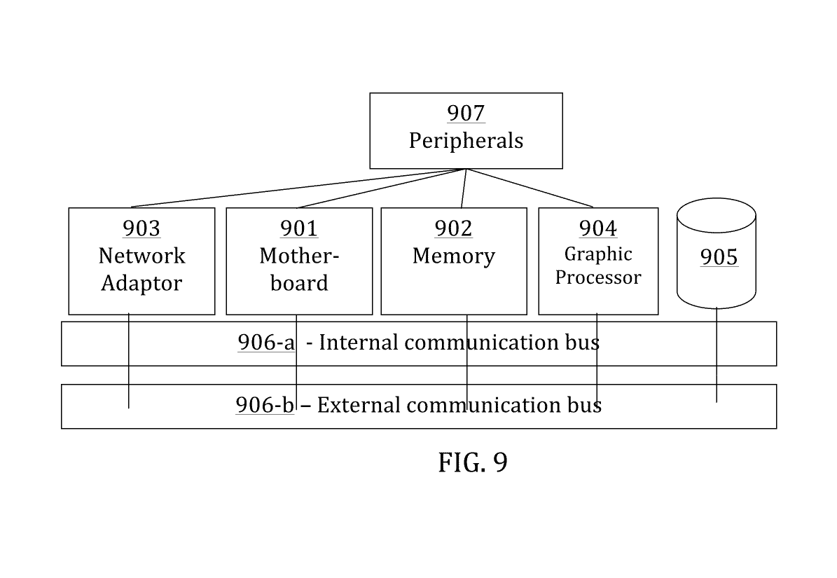

FIG. 9 shows a simplified block diagram of a processing system in which some embodiments of the invention and that may be present in some system embodiments. The drawing shows an example computer infrastructure, which can support these systems and methods. Computer systems are well known in the industry and are by themselves not part of this invention. The description provided here is for illustrative purposes only. A computer typically consists of a motherboard 901, containing the central processing unit or CPU. Peripherals, represented by 907, such as keyboards, displays, mouse or other input/output devices can be connected to this motherboard, or to other components of the computer, such as a network adaptor 903, a memory (902) or a graphic processor board 904. These components may reside on the motherboard itself or may be separate components inside the computer. These components themselves may contain processors and memory to execute their tasks. The graphic input/output board may contain memory and graphic processors to display graphics on a display device. Typically a computer contains a more permanent storage device, or hard disk, represented by 905. 902 and 905 represent computer readable media where instructions can be stored. When executed by a computer processor these instructions can perform one ore more steps of one or more embodiments described in this disclosure. The different components of the computer can communicate with one another, and exchange data and signals with each other over one or more so called (communication) buses, both of the internal or external kind, as represented by 906-a and 906-b. This computer hardware infrastructure can host one or more software applications, which can execute one, or more of the functions needed to implement this invention.

In one embodiment, this invention may rely on one or more computers to implement some or all of the functions and methods needed for this invention. Note that in such cases, the computer system includes a non-transitory computer-readable medium that is configured by instructions that when executed by at least one processor, e.g., CPU, carries out one of more of the method steps of the methods described herein.

Typically, when multiple computers are involved they can communicate with one another, for instance through a network, and each can have specific functions within the context of this invention.

### Supporting Network Infrastructures

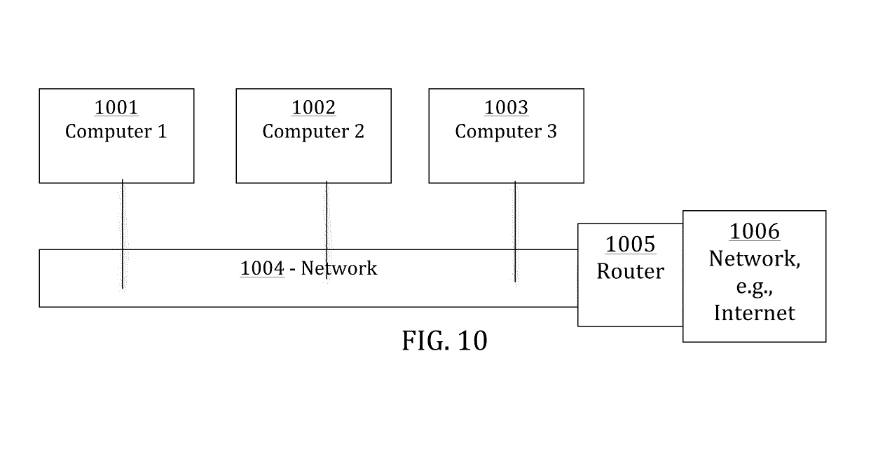

As an example, FIG. 10 shows a very simple network, with three computers 1001, 1002, 1003, connected over a network 1004. A network can have a network router or a network switch 1005, which can connect this network to a larger network 1006, e.g., the Internet. The computers 1001-1003 include, in their storage instructions that when execute, carry out some or all the steps described herein. As an example one computer has, in storage a product database and instructions for managing the database, another computer includes instructions for operating an online store and a server for servicing the Web pages for the online store, yet another computer includes instructions for collecting payments from the customer and distributing payments amongst the appropriate value-chain members.

In one implementation the computers can each connect into the router. It will be clear to anyone skilled in the art that the architecture can vary greatly and that any computer architecture, implementing different possible functions, is essentially equivalent with respect to this invention.

### CONCLUSION, RAMIFICATIONS AND SCOPE

The reader will see that embodiment of the invention can provide a beneficial sales model for members of a value chain, for customers and for recipients. One benefit of one embodiment is that there is no requirement for value-chain endpoints to be involved in the ordering and fulfillment process, while still receiving monetary benefits for these value-chain members. The costs of doing business for the retailers, or more generally the value-chain endpoints, are therefore drastically decreased. Hence this method can be used in more locations and can enable certain products to serve its original purpose, for instance as a decorative or functional item, or as a needed in situ service or product, and can now also become a source of additional income for the value-chain endpoint, and for other value-chain members. Another benefit of one embodiment is that the system allows for new product creation by customers, triggered by similar products available in the physical store, while the new products are not yet available in physical stores, and while maintaining a finder fees for these physical stores.

Another benefit of one embodiment is that the system allows for “extension of the value-chain endpoint” beyond the traditional walls of a retail outlet. As an example a post card mailed to a recipient, from a first retailer, can now become a value-chain endpoint used at the recipient's home and become a source of income for the first retailer; again without the need for the retailer to be involved in the fulfillment process of products sold through the recipient of the post card.

Another benefit of one embodiment is the “rapid value-chain endpoint multiplication,” which can increase the number of sales points for the products and services quickly and therefore mean higher growth and market penetration for the companies using embodiments of this invention. In one embodiment, customers can very easily become value-chain endpoints themselves and earn money with sales originating from these customers.

A benefit for customers is that embodiments of this invention provide a way to see or hear the product and services or a very good display thereof, in real life, before making a purchase decision on a website. For the retailer displaying the product and actually not fulfilling it through the physical store, provides a huge benefit in terms of inventory and sales and administrative overhead costs.

For a customer embodiments also provide ease of use and the convenience of being able to make purchases of products that are more difficult to transport back home, such as larger or heavier items, or items that are prohibited on certain transportation systems, such as larger amounts of liquid on planes, or items that are very expensive to transport, or items that may be perceived as dangerous to transport on passenger planes.

Another benefit of one embodiment of the system includes the ability to deliver relevant personalized messages to occasional or even one-time customers in a physical store. It is very difficult for retailers to collect meaningful information about their customers and it is even more difficult or impossible to do so when the customers are one-time or occasional customers, such as tourists. One embodiment has the ability to collect and store purchasing history for registered customers, over multiple retailers over a longer period of time. One aspect of this embodiment now allows delivering relevant information to value-chain members and occasional or one-time customers. As an example, in one embodiment, product displays on screens in retail environments, can be adapted to themes that resonate with the particular customer near the screen. The concept of personalized communication now actually becomes possible in at least one embodiment, and will be beneficial to the retailers, manufacturers and brand owners and customers.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the DESCRIPTION OF EXAMPLE EMBODIMENTS are hereby expressly incorporated into this DESCRIPTION OF EXAMPLE EMBODIMENTS, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified, the use of the ordinal adjectives “first,” “second,” “third,”, and so forth, to describe a common object, merely indicate that different instances of like objects are being referred to, and are not intended to imply that the objects so described must be in a given sequence, either temporally, spatially, in ranking, or in any other manner.

All U.S. patents, U.S. patent applications, and International (PCT) patent applications designating the United States cited herein are hereby incorporated by reference, except in those jurisdictions that do not permit incorporation by reference, in which case the Applicant reserves the right to insert any portion of or all such material into the specification by amendment without such insertion considered new matter. In the case the Patent Rules or Statutes do not permit incorporation by reference of material that itself incorporates information by reference, the incorporation by reference of the material herein excludes any information incorporated by reference in such incorporated by reference material, unless such information is explicitly incorporated herein by reference.

Any discussion of other art in this specification should in no way be considered an admission that such art is widely known, is publicly known, or forms part of the general knowledge in the field at the time of invention.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting of only elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other, but may be. Thus, the scope of the expression “a device A coupled to a device B” or the expression “a device A connected to a device B” should not be limited to devices or systems wherein an input or output of device A is directly connected to an output or input of device B. It means that there exists a path between device A and device B which may be a path including other devices or means in between. Furthermore, “coupled to” and “connected to” do not imply direction. Hence, the expression “a device A is coupled to a device B” may be synonymous with the expression “a device B is coupled to a device A.” “Coupled” and “connected” may mean that two or more elements are either in direct physical or electrical contact, or that two or more elements are not in direct contact with each other but yet still co-operate or interact with each other. Similarly a connection device enables the connection between two or more elements and does not imply a direction neither does it imply a that the device connects the output of one device directly to the inputs of another devices. A connection device enables the cooperation between two or more other elements or devices.

In addition, use of the “a” or “an” are used to describe elements and components of the embodiments herein. This is done merely for convenience and to give a general sense of the invention. This description should be read to include one or at least one and the singular also includes the plural unless it is obvious that it is meant otherwise.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention, to the extent permitted by law. For example, to the extent permitted by law: any formulas given are merely representative of procedures that may be used; functionality may be added or deleted from the block diagrams and operations may be interchanged among functional blocks; and steps may be added to or deleted from methods described within the scope of the present invention.

Unless specifically stated otherwise, as apparent from the following description, it is appreciated that throughout the specification discussions utilizing terms such as “processing,” “computing,” “calculating,” “determining” or the like, may refer to, without limitation, the action and/or processes of hardware, e.g., an electronic circuit, a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

Note that when a method is described that includes several elements, e.g., several steps, no ordering of such elements, e.g., of such steps is implied, unless specifically stated.

The methodologies described herein are, in some embodiments, performable by one or more processors that accept logic, instructions encoded on one or more computer-readable media. When executed by one or more of the processors, the instructions cause carrying out at least one of the methods described herein. Any processor capable of executing a set of instructions (sequential or otherwise) that specify actions to be taken is included. Thus, one example is a typical processing system that includes one or more processors. Each processor may include one or more of a CPU or similar element, a graphics processing unit (GPU), field-programmable gate array, application-specific integrated circuit, and/or a programmable DSP unit. The processing system further includes a storage subsystem with at least one storage medium, which may include memory embedded in a semiconductor device, or a separate memory subsystem including main RAM and/or a static RAM, and/or ROM, and also cache memory. The storage subsystem may further include one or more other storage devices, such as magnetic and/or optical and/or further solid state storage devices. A bus subsystem may be included for communicating between the components. The processing system further may be a distributed processing system with processors coupled by a network, e.g., via network interface devices or wireless network interface devices. If the processing system requires a display, such a display may be included, e.g., a liquid crystal display (LCD), organic light emitting display (OLED), or a cathode ray tube (CRT) display. If manual data entry is required, the processing system also includes an input device such as one or more of an alphanumeric input unit such as a keyboard, a pointing control device such as a mouse, and so forth. The term storage device, storage subsystem, or memory unit as used herein, if clear from the context and unless explicitly stated otherwise, also encompasses a storage system such as a disk drive unit. The processing system in some configurations may include a sound output device, and a network interface device.

In some embodiments, a non-transitory computer-readable medium is configured with, e.g., encoded with instructions, e.g., logic that when executed by one or more processors of a processing system such as a digital signal processing device or subsystem that includes at least one processor element and a storage subsystem, cause carrying out a method as described herein. Some embodiments are in the form of the logic itself A non-transitory computer-readable medium is any computer-readable medium that is statutory subject matter under the patent laws applicable to this disclosure, including Section 101 of Title 35 of the United States Code. A non-transitory computer-readable medium is for example any computer-readable medium that is not specifically a transitory propagated signal or a transitory carrier wave or some other transitory transmission medium. The term “non-transitory computer-readable medium” thus covers any tangible computer-readable storage medium. In a typical processing system as described above, the storage subsystem thus includes a computer-readable storage medium that is configured with, e.g., encoded with instructions, e.g., logic, e.g., software that when executed by one or more processors, causes carrying out one or more of the method steps described herein. The software may reside in the hard disk, or may also reside, completely or at least partially, within the memory, e.g., RAM and/or within the processor registers during execution thereof by the computer system. Thus, the memory and the processor registers also constitute a non-transitory computer-readable medium on which can be encoded instructions to cause, when executed, carrying out method steps. Non-transitory computer-readable media include any tangible computer-readable storage media and may take many forms including non-volatile storage media and volatile storage media. Non-volatile storage media include, for example, static RAM, optical disks, magnetic disks, and magneto-optical disks. Volatile storage media includes dynamic memory, such as main memory in a processing system, and hardware registers in a processing system.

While the computer-readable medium is shown in an example embodiment to be a single medium, the term “medium” should be taken to include a single medium or multiple media (e.g., several memories, a centralized or distributed database, and/or associated caches and servers) that store the one or more sets of instructions.

Furthermore, a non-transitory computer-readable medium, e.g., a computer-readable storage medium may form a computer program product, or be included in a computer program product.

In alternative embodiments, the one or more processors operate as a standalone device or may be connected, e.g., networked to other processor(s), in a networked deployment, or the one or more processors may operate in the capacity of a server or a client machine in server-client network environment, or as a peer machine in a peer-to-peer or distributed network environment. The term processing system encompasses all such possibilities, unless explicitly excluded herein. The one or more processors may form a personal computer (PC), a media playback device, a headset device, a hands-free communication device, a tablet PC, a set-top box (STB), a Personal Digital Assistant (PDA), a game machine, a cellular telephone, a Web appliance, a network router, switch or bridge, or any machine capable of executing a set of instructions (sequential or otherwise) that specify actions to be taken by that machine.

Note that while some diagram(s) only show(s) a single processor and a single storage subsystem, e.g., a single memory that stores the logic including instructions, those skilled in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, as will be appreciated by those skilled in the art, embodiments of the present invention may be embodied as a method, an apparatus such as a special purpose apparatus, an apparatus such as a data processing system, logic, e.g., embodied in a non-transitory computer-readable medium, or a computer-readable medium that is encoded with instructions, e.g., a computer-readable storage medium configured as a computer program product. The computer-readable medium is configured with a set of instructions that when executed by one or more processors cause carrying out method steps. Accordingly, aspects of the present invention may take the form of a method, an entirely hardware embodiment, an entirely software embodiment or one embodiment combining software and hardware aspects. Furthermore, the present invention may take the form of program logic, e.g., a computer program on a computer-readable storage medium, or the computer-readable storage medium configured with computer-readable program code, e.g., a computer program product.

It will also be understood that embodiments of the present invention are not limited to any particular implementation or programming technique and that the invention may be implemented using any appropriate techniques for implementing the functionality described herein. Furthermore, embodiments are not limited to any particular programming language or operating system.

While the description above contains many specificities, these should not be construed as limitations of the scope. They are meant to provide examples of embodiments and clearly many other variations are possible, as should be obvious from the description we provided.

Accordingly the scope should be determined by the appended claims and their legal equivalents.

We claim:

1. A method for operating a processing system to enable customers to make purchases from at least one value-chain endpoint, the method comprising the steps of:
receiving in the processing system an order for at least one product, including receiving at least one identifier, the order originating at one or more value-chain endpoints;
determining, using the at least one identifier, one or more value-chain members for the value-chain of order;
determining respective compensations for the one or more determined value-chain members;
causing distribution of the respective determined compensations to the one or more determined value-chain members; and
causing delivery of the at least one product to at least one recipient.

2. The method of claim 1, wherein the at least one identifier is communicated from at least one identifier carrier to an order entry system.

3. The method of claim 1, wherein the at least one product comprises one or more of a physical product, a digital product, and a service.

4. The method of claim 1, further comprising the steps of establishing each of the at least one customer or the at least one recipient as a respective new value-chain endpoint, such that each new value-chain endpoint can receive compensation as a result of a purchase made at the new value-chain endpoint.

5. The method of claim 1, further comprising the step of:
delivering personalized messages to one or more of the at least one customer, the at least one recipient, and the one or more value-chain members.

6. The method of claim 2, further comprising:
analyzing purchase data and the at least one identifier to determine whether there has been one or both fraudulent usage of the cooperation manager, and damage to at least one identifier carrier.

7. The method of claim 1 further comprising selecting manufacturing or fulfillment workflows by the at least one customer, based on preferences of the at least one customer or of the at least one recipient.

8. A system for operating a cooperation manager to enable customers to make purchases from at least one value-chain endpoint using a cooperation manager, the system comprising:
a module operative to accept from a customer at least one order for at least one product from the at least one value-chain endpoint;
a module operative to receive order information and at least one identifier;
a module operative to determine at least one value-chain member, using at least one identifier;
a module operative to determine respective compensations for the at least one value-chain member;
a module operative to cause distribution of the respective compensations to the at least one identified value-chain member; and
a module operative to cause delivery of the at least one product to at least one recipient.

9. The system of claim 8 further comprising a module operative to communicate the at least one identifier from at least one identifier carrier to an order entry system.

10. The system of claim 8 wherein the at least one product comprises one or more of a physical product, a digital product and a service.

11. The system of claim 8, further comprising a module operative to establish the at least one customer or the at least one recipient as a new value-chain endpoint.

12. The system of claim 11, further comprising a module operative to distribute compensation to the new value-chain endpoint.

13. The system of claim 8, further comprising a module operative to deliver personalized messages to one or more of:
one or more of the at least one customer;
one or more of the at least one recipient; and
one or more of the at least one value chain member.

14. The system of claim 9, further comprising a module operative to analyze purchase data and the at least one identifier, to establish fraudulent usage of the cooperation manager or damage to the at least identifier carrier.

15. The system of claim 8, further comprising a module operative to select manufacturing or fulfillment workflows for the at least one customer, based on preferences of the at least one customer or the at least one recipient.

16. A method of operating a processing system, the method comprising:
receiving order information from a customer, for at least one product, and at least one identifier information over a communication link, and storing the information into a non-transitory computer memory;
using the order and the identifier information to retrieve at least one value-chain member information from a non-transitory computer memory;
retrieving at least one compensation distribution rule from a non-transitory computer memory;
using the order, value-chain member and the rule information to determine compensation distribution to the at least one value-chain member;
delivering the compensation to the at least one value-chain member; and
delivering the at least one product to at least one recipient.

17. A method as recited in claim 16, wherein the at least one recipient or the customer can operate the processing system to establish him or her as a new value-chain endpoint.

18. An apparatus comprising:
one or more server processing systems; and
one or more client processing systems coupled to the one or more server processing systems by a network;
wherein the one or more server processing systems and the one ore more client processing systems configured, such that purchase order and value-chain endpoint information are communicated between at least one client processing system and at least one server processing system;
wherein the one or more server processing systems are configured to determine at least one value-chain member; and
wherein the one or more server processing systems are further configured to determine and distribute compensation.

19. An apparatus as recited in claim 18, wherein the one ore more server processing systems and one or more client processing systems are further configured to create new value-chain endpoints as part of the value chain.

20. A non-transitory computer-readable medium configured with instructions that when executed by one or more processors of a processing system, cause carrying out a method of operating a cooperation manager, the method comprising:
receiving an order from at least one customer, for at least one product, the receiving also receiving at least one identifier;
determining one or more value-chain members for the order, using the at least one identifier;
determining respective compensations for the one or more determined value-chain members;
causing distribution of the respective determined compensations to the one or more determined value-chain members; and
causing delivery of the at least one product to at least one recipient.

21. The non-transitory computer-readable medium of claim 20, wherein the method further comprises establishing the at least one customer or the at least one recipient as one or more respective new value-chain endpoints.
